(19) United States
(12) Patent Application Publication
(10) Pub. No.: US 2026/0349684 A1
(43) Pub. Date: Nov. 5, 2026

(54) TRANSFORMING UX DESIGNS INTO CODE USING MACHINE LEARNING MODEL

(71) Applicant: AidenAi, Inc, Princeton, NJ (US)

(72) Inventor: Srinivas Kamadi, Princeton, NJ (US)

(21) Appl. No.: 19/662,124

(22) Filed: Apr. 29, 2026

Related U.S. Application Data
(60) Provisional application No. 63/797,364, filed on Apr. 30, 2025.

(51) Int. Cl. G06F 8/35; G06F 8/10; G06F 8/36; G06F 8/38; G06F 8/41; G06F 8/60; G06N 20/00

(52) U.S. Cl. CPC G06F 8/35; G06F 8/10; G06F 8/36; G06F 8/38; G06F 8/427; G06F 8/447; G06F 8/60; G06N 20/00

(57) ABSTRACT

A system for transforming at least one of User Interface (UI) design or User Experience (UX) design into target platform outputs is disclosed. The system includes at least one processor and a memory storing executable instructions. The processor extracts design information from UI/UX design files and analyzes the extracted information using machine learning based classification to identify UI components, layouts, styles, states, relationships, data models, and navigational behaviors. The processor parses the extracted design information into a self-evolving application model and further analyzes the parsed information using machine learning based classification. The processor performs cross-page analysis to identify reusable components and consolidate page variations. Based on the analyzed design information and the cross-page analysis, the processor transforms and generates target platform compatible outputs deployable to at least one low code/no code platform or open source UI framework.

### FIELD

The present disclosure relates to transforming user interface (UI) design or user experience (UX) design into target platform outputs.

### BACKGROUND

The information disclosed in this background section is only for enhancement of understanding of the general background of the disclosure and should not be taken as an acknowledgement or any form of suggestion that this information forms the prior art already known to a person skilled in the art.

User interface (UI) design and user experience (UX) design collectively relate to the activities performed to define how an application appears to a user and how the user interacts with the application during operation. UI design primarily concerns the visual elements of an application, including screen layouts, controls, styles, themes, and navigation elements, whereas UX design relates to structuring and visualizing the user journey and interactions to ensure coherent and usable application behavior. In the context of software development, UI/UX design forms an integral part of defining the functional and visual behavior of an application prior to implementation.

In a design phase of a software development life cycle (SDLC), UI/UX tools play a crucial role in defining how the application will look and function, as shown in FIG. 1. Traditionally, UI/UX designers collaborate with different stakeholders of the system to understand requirements, user needs, and expected application behavior. Based on such collaboration, the designers follow a sequence of activities that collectively contribute to the preparation of design artifacts intended to guide subsequent development or configuration activities.

A first activity in the traditional process is wireframing, wherein workshops are conducted with stakeholders to capture the user journey. During this step, basic screen layouts are created with a focus on structure and navigation. The wireframes serve as an initial representation of how different screens are organized and how a user is expected to move between such screens, without incorporating detailed visual styling or interactive behavior.

Following wireframing, a prototyping activity is performed. During the prototyping activity, interactive prototypes are created to simulate real application interactions. These prototypes assist in visualizing how users will interact with the application and enable stakeholders to review the flow of interactions across different screens. The prototyping step builds upon the outputs of wireframing by adding interaction behavior to the previously defined structure and navigation.

Subsequently, a UI design activity is carried out, wherein designers create pixel-perfect, high-fidelity designs. This activity includes defining branding elements, typography, and colors, and often involves applying design systems and reusable components. The resulting UI designs provide clear visual references intended for developers or configurators and reflect the finalized appearance of the application screens.

The designs prepared through the wireframing, prototyping, and UI design activities, including application layout, controls, styles, themes, and navigations are manually designed by the UI/UX designers using the UI/UX tools. These designs typically undergo several repeated review cycles and manual rework processes in order to arrive at a finalized and approved version suitable for sign-off by stakeholders.

Once approved, the finalized designs are coded or configured manually in the target low-code or no-code platforms, or in open source UI frameworks, by configurators or developers. This manual coding or configuration stage translates the approved design artifacts into executable or deployable application interfaces, thereby completing the transition from design to implementation within the SDLC.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment, the present disclosure relates to a system for transforming at least one of a user interface (UI) design or a user experience (UX) design into target platform outputs. The system comprises at least one processor and a memory storing executable instructions, wherein the at least one processor is configured to perform a series of interrelated operations for processing UI/UX design information.

The processor is configured to extract design information from one or more UI/UX design files, wherein the design information comprises at least one of page-level metadata, application-level metadata, referenced component metadata, image representations, and prototype navigation information. The processor is further configured to parse the extracted design information into a self-evolving application model. The parsed design information is analyzed using machine learning-based classification to identify at least one of UI components, layouts, styles, states, relationships, data models, and navigational behaviors. The processor is further configured to perform cross-page analysis to identify reusable components and consolidate page variations. Based on the analyzed design information and the cross-page analysis, the processor is further configured to transform and generate target platform-compatible outputs deployable to at least one low code/no code platform or open source UI framework.

According to one embodiment, the present disclosure relates to a method for transforming at least one of a user interface (UI) design or a user experience (UX) design into target platform outputs. The method includes extracting design information from UI/UX design files, the design information comprising metadata, images, and prototype navigation information. The method further includes parsing the extracted design information into a self-evolving application model. The method further includes analyzing the parsed design information using machine learning-based classification to identify UI components, layouts, styles, states, relationships, data models, and navigation behaviors. The method further includes performing cross-page analysis to identify reusable components and consolidate page variations. The method further includes transforming and generating target platform-compatible configurations or code, based on the analyzed design information and the cross-page analysis, and deploying the generated outputs to the target platform.

According to one embodiment, the present disclosure relates to a non-transitory computer-readable medium storing instructions which, when executed by one or more processors of an electronic device, cause the electronic device to perform one or more operations associated with the system.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a user interface (UI) design or user experience (UX) design tool with various functionalities related to a design system and associated components, along with an overview of application design and prototype, according to an embodiment of the present disclosure;

FIG. 2 illustrates a block diagram of a system that provides a high-level view of the transformation of application design into a target platform, including submodules, according to an embodiment of the present disclosure;

FIG. 3 illustrates one or more submodules associated with an extractor, along with their corresponding functionalities, according to an embodiment of the present disclosure;

FIG. 4 illustrates one or more submodules associated with a parser, along with their corresponding functionalities, according to an embodiment of the present disclosure;

FIG. 5 illustrates one or more submodules associated with a detector, along with their corresponding functionalities, according to an embodiment of the present disclosure;

FIG. 6 illustrates one or more submodules associated with an analyzer, along with their corresponding functionalities, according to an embodiment of the present disclosure;

FIG. 7 is a flow diagram illustrating a method for transforming at least one of UI design or UX design into target platform outputs, according to an embodiment of the present disclosure;

FIGS. 8A-8E illustrates an exemplary scenario transforming UX designs into code using a machine learning (ML) model, according to an embodiment of the present disclosure; and

FIG. 9 illustrates a diagram of example components of an apparatus, according to an embodiment of the present disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments, one or more operations may be omitted, one or more operations may be added, or one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description, but is not intended to be exhaustive or to limit the implementations to the precise form disclosed. Modifications and variations are possible in light of the above disclosure or may be acquired from practice of the implementations.

In the present disclosure, specific tasks may be performed using artificial intelligence/machine learning (AI/ML) models. An AI/ML model is a model generated using one or more AI technologies, one or more ML algorithms, or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transudative learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

User interface (UI) design and user experience (UX) design define the visual appearance and interaction behavior of an application and are integral to the design phase of the software development life cycle (SDLC). UI/UX tools are traditionally used by designers in collaboration with multiple system stakeholders to translate requirements into design artifacts that guide implementation. The conventional process involves wireframing to capture the user journey and basic screen layouts with emphasis on structure and navigation, followed by prototyping to create interactive representations that simulate real application interactions. Subsequently, UI design is performed to produce pixel-perfect, high-fidelity designs incorporating branding, typography, colors, and reusable components, thereby providing clear visual references for developers. The resulting application layouts, controls, styles, themes, and navigation elements are manually created and subjected to multiple review and rework cycles before approval. Upon signoff, the approved designs are manually coded or configured in target low-code or no-code platforms, or open-source UI frameworks, by configurators or developers.

In conventional application development practices, UI/UX designs are manually coded or configured during the implementation stage. As a result, UI/UX designers are required to spend a significant amount of time interacting with various stakeholders through workshops in order to capture requirements manually. This requirement gathering process is inherently time-consuming and is susceptible to gaps in understanding between different stakeholders. Such gaps often result in multiple rounds of review, clarification, and manual rework before the designs reach a stage suitable for approval.

Further, the quality and effectiveness of the visual representation and user interaction defined in the UI/UX designs depend largely on the creativity and expertise of individual UI/UX designers. Consequently, the resulting designs may vary in consistency and interpretability, thereby increasing dependency on subjective design skills rather than a structured or standardized process.

At the application development stage, additional challenges arise for UI engineers and developers who are responsible for building and styling the application based on the finalized UI/UX designs and prototypes. These engineers typically spend several weeks to months converting the design artifacts into executable application pages. This manual translation from design to implementation significantly extends development timelines and increases effort.

Although certain tools are available in the market to assist in converting designs into code, the outputs generated by such tools still require a substantial amount of time from developers for refactoring in accordance with best practices and compatibility with a target platform. This limitation exists, at least in part, because the generated outputs are predominantly generic HTML elements, such as <div/>, rather than platform-specific components aligned with the target framework. Additionally, such tools lack the capability to generate outputs in proprietary formats required by low-code or no-code platforms.

Another limitation of existing approaches is the inability to perform reconciliation when UI/UX designs are updated in parallel with earlier generated code. In practice, designs frequently undergo a series of updates even after page development has commenced. Existing tools do not provide mechanisms to identify delta changes made in updated designs, regenerate code for existing pages, or manage reconciliation between previously generated code and modified designs.

In addition, existing UI/UX design tools and third-party extensions in the existing system exhibit several limitations, for example:
a. Automation of user journeys based on domain, subdomain, and application requirements is not supported, resulting in considerable time spent in workshops by the UI/UX designers and stakeholders to brainstorm user journeys.
b. Recommendations for optimal UI designs and creative alternatives for the UI/UX designers are lacking. While fixed templates are available, tailored UI design recommendations based on specific application requirements are not present.
c. Each low-code/no-code product utilizes proprietary formats for configuration storage, with minimal publicly available sample configurations. This scarcity of data hinders machine learning (ML) models from generating configurations that align closely with designs created by UI/UX designers.
d. The creation of navigational flows between screens based on prototypes produced by UI/UX designers is not feasible within target platforms.
e. Outputs intended for translation to open-source frameworks do not generate framework-specific components; instead, they produce generic HTML controls. This necessitates additional time for developers to modify generated HTML into framework-specific components.
f. Existing models generate independent screens without considering the user journey, lacking the ability to extract insights about user journeys from prototypes for target code or configuration generation.
g. Existing models produce only frontend files without summarizing screens or deriving data models based on the screens and fields utilized in the flow.
h. The capability to identify reusable widgets or components across screens for the creation of custom reusable components is absent, as the approach remains screen-by-screen without a consolidated view.
i. Developers and configurators invest substantial time in either creating or retrofitting auto-generated files manually.
j. A human-in-the-loop feature for reviewing and validating outcomes, along with mechanisms for feedback to enhance transformation processes, is not available. Self-evolving features that learn from user inputs to improve subsequent transformations are also lacking.
k. Onboarding of enterprise-specific component libraries for utilization during target configuration generation is not supported.
l. The offerings are primarily software as a service (SaaS) without options for self-hosting, whether on-premises or in a private cloud.
m. While options exist to export cascading style sheets (CSS) styles, these exports are often incompatible with or non-compliant with low-code/no-code platform specifications or UI framework-specific classes, resulting in additional time for the UI/UX designers to apply styles according to target platform requirements.

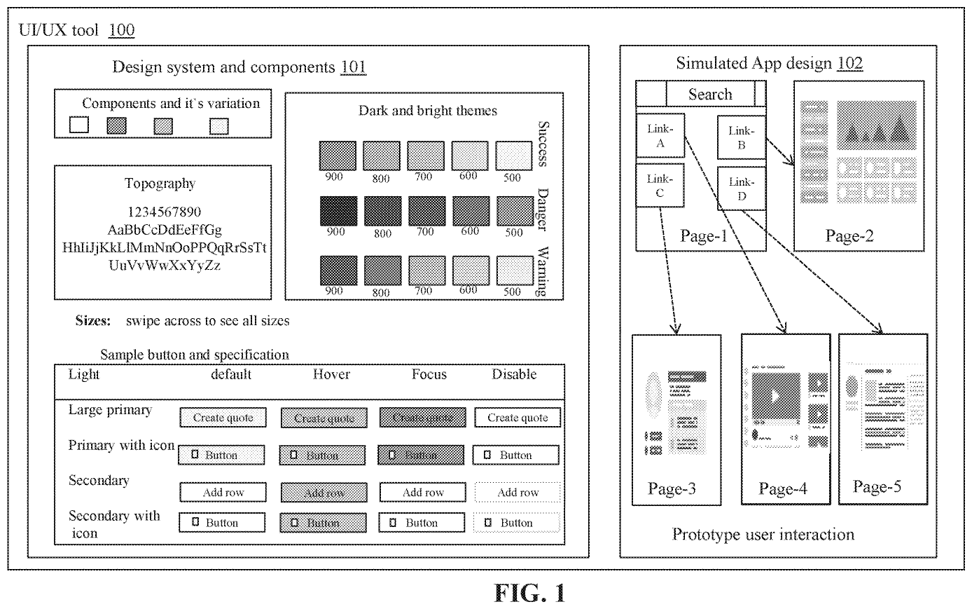

To address the above-mentioned challenges/problems/limitations, a disclosed method provides a unique strategy for transforming UI design or UX design into target platform outputs, as described in conjunction with FIG. 1 to FIG. 9.

The present disclosure relates to a system or method capable of detecting personas and user journeys involved in a software application based on a domain, a subdomain, and an application description. The detection of personas and user journeys is performed by interpreting the application context provided through the domain, subdomain, and application description, thereby enabling identification of the user roles and interaction paths relevant to the application. Based on the detected personas and user journeys, the innovation recommends alternative journeys and possible UI designs during wireframing and prototyping, and further facilitates the creation of high-fidelity screens aligned with the identified user journeys.

The disclosed system and/or method follows a technique that combines image pattern analysis with analysis of raw metadata extracted from design files, along with analysis of the Design System and its component definition available in UI/UX design tools. The technique processes image representations present in the design files while simultaneously analyzing structural and descriptive metadata contained within the same design files. The design system and its component definitions available in the UI/UX design tools are also considered during analysis to establish correspondence between visual elements, metadata, and predefined design components.

The image analysis technique is tailored to handle UI/UX designs directly from the design files. The technique automatically relates metadata information extracted from the design files with information derived from the Design System. Such metadata and design system information are maintained in proprietary design files by each UI/UX design tool. The model is trained to handle different formats and different structures of such proprietary design files, thereby enabling consistent processing across varying UI/UX tools.

The technique analyzes individual design files while maintaining the capability to keep track of analyzed information across multiple files and screens. By correlating analyzed information across files and screens, the technique provides a customized summarization of the overall theme of the system, typography, reusable sections across the screens, styles that can be reused across controls, layouts, and other related details. The customized summarization is derived by consolidating analysis results from multiple design artifacts.

Further, the disclosed system and/or method detects variations of controls automatically, including primary state, disabled state, focused state, and other states. The technique identifies variations in the state of the same page, such as a collapsed version of a section and an expanded version of the same section. For example, the technique detects a view of a page when the page is loaded and a corresponding view when a dropdown field or a date field's calendar view is expanded. By detecting multiple states of the same page, the technique consolidates state information and applies corresponding effects consistently across the design representation.

The disclosed system and/or method aims to provide guided or assisted user experience design by understanding application requirements and automatically identifying personas involved. Based on the identified personas, the invention brings user journeys and user interaction with navigation that fit the application requirements. The invention further recommends high-fidelity UI design for pages and provides alternative design options for selection. Based on additional inputs from a user, the designs can be revamped, thereby enabling iterative refinement of user experience design while maintaining alignment with application requirements.

Referring now to the drawings, and more particularly to FIGS. 1 to 9, where similar reference characters denote corresponding features consistently throughout the figures, their preferred embodiments are shown.

FIG. 1 illustrates a UI design or UX design tool 100 with various functionalities related to a design system and associated components, along with an overview of application design and prototype, according to an embodiment of the present disclosure. The illustrated UI/UX design tool 100 provides a unified environment in which design system definitions, component specifications, and application-level designs are visually organized and interconnected to enable consistent UI/UX design and prototyping.

As shown in FIG. 1, a first portion of the UI/UX design tool 100 presents the design system and its components 101. This portion 101 includes representations of components and their variations, typography definitions, dark and bright themes, and sample button specifications. The component variations depict multiple visual states of the same component, while typography information specifies font styles and sizes applicable across the application. The dark and bright themes illustrate color schemes maintained within the design system, and the sample button specifications demonstrate different button styles and interaction states, such as default, hover, focus, and disabled. Collectively, these elements define standardized visual and interaction properties that are reusable across multiple application screens.

A second portion of FIG. 1 illustrates a simulated application design 102 comprising multiple pages of the application, represented as Page 1 through Page 5. These pages correspond to high-fidelity UI designs derived from the design system and its components. The simulated application design 102 visually represents the application layout and screen structure as it would appear during execution. Arrows between the pages indicate prototype user interaction, showing navigation paths between different pages based on user actions. This prototype interaction visually conveys how user journeys are realized across the application pages.

FIG. 1 further illustrates that individual pages within the simulated application design 102 reference components, styles, and layouts defined in the design system. By maintaining this association, changes in component specifications or themes within the design system can be reflected consistently across all pages. The presence of navigation arrows demonstrates how prototype interaction information is associated with page designs, thereby enabling visualization of user flows and navigation sequences during the design and prototyping stage.

The UI/UX design tool 100 as depicted enables designers to view both design system definitions and application level designs concurrently. This integrated view supports alignment between component definitions, visual styles, and page level implementations.

The illustration shown in FIG. 1 enables a consistent and structured approach to UI/UX design by visually integrating design system components, application page designs, and prototype user interaction within a single UI/UX design tool 100. This alignment supports the reuse of components, consistent visual representation across pages, and clear visualization of navigation flows, thereby facilitating coherent application design and effective prototype review based on the defined design system and associated components.

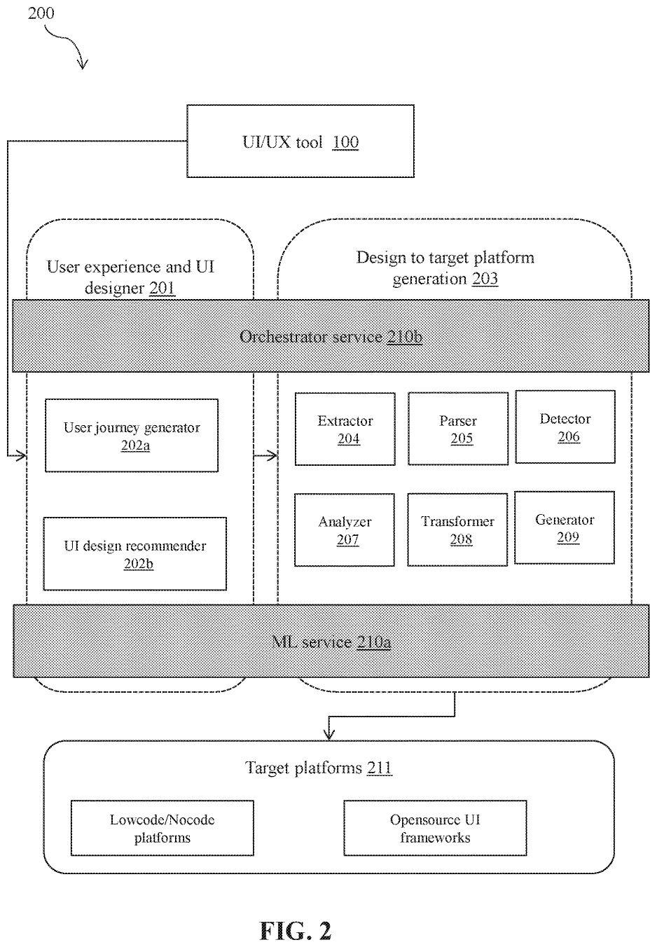

FIG. 2 illustrates a block diagram of a system 200 that provides a high-level view of the transformation of application design into a target platform, including submodules, according to an embodiment of the present disclosure.

In one or more embodiments, the system 200 may include the UI/UX tools 100, a user experience and UI designer 201, a design target platform generation 203, one or more ML services 210a, an orchestrator service 210b and a target platform 211. The system 200 may perform a sequence of operations that are orchestrated by a centralized service and make use of one or more ML services 210a in each one of these operations.

In one or more embodiments, the user experience and UI designer 201 may include a user journey generator 202a, a UI design recommender 202b, and operations related to each module are described below.

In one or more embodiments, the user journey generator 202a may create detailed personas and user journeys tailored to specific domains, sub-domains, and application descriptions. The user journey generator 202a may systematically generate various scenarios, including comprehensive representations of main flows, which illustrate the end-to-end transaction processes that users may encounter within the application. Additionally, user journey generator 202a may depict alternate flows based on diverse application use cases, accommodating variations in user behavior and decision-making. The user journey generator 202a may also identify potential negative flows and validation checks, ensuring robust handling of unexpected user actions and system responses. To enhance user experience, the user journey generator 202a may also offer recommendations for the initial steps users should take and outline subsequent actions that are logically possible, thereby effectively guiding navigation. Furthermore, the user journey generator 202a may provide strategies for presenting summary information and facilitating navigation to subsequent pages, along with a clear delineation of allowable actions.

In one or more embodiments, the UI design recommender 202b may utilize application requirements and specifications to propose optimal design solutions. The UI design recommender 202b may offer recommendations for the most effective user interface layouts that enhance usability and accessibility, as well as strategic positioning of UI components to maximize user engagement. The UI design recommender 202b may provide guidance on the sequential display of information, ensuring that users receive content in a logical and meaningful order. The UI design recommender 202b may also suggest methods for segmenting screens to improve clarity and focus, allowing users to navigate complex information more easily. Additionally, the UI design recommender 202b may offer insights into the best ways to present data, whether through table views, form views, or other visual formats. The UI design recommender 202b may include a curated list of essential fields to be captured on each page, ensuring efficient collection of necessary user data. Finally, UI design recommender 202b may outline strategies for visualizing aggregated data to facilitate informed decision-making and actionable insights.

In one or more embodiments, the design target platform generation 203 may employ a systematic approach to adapt designs for specific target platforms 211. This process is orchestrated by a centralized service that coordinates the transformation and utilizes multiple machine-learning services throughout various stages. The approach involves a structured sequence of operations that ensures a coherent transition from design to implementation. By integrating machine learning services at each step, the design target platform generation 203 may enable intelligent decision-making and adaptive design adjustments based on real-time data and user feedback, enhancing the overall effectiveness of the design process.

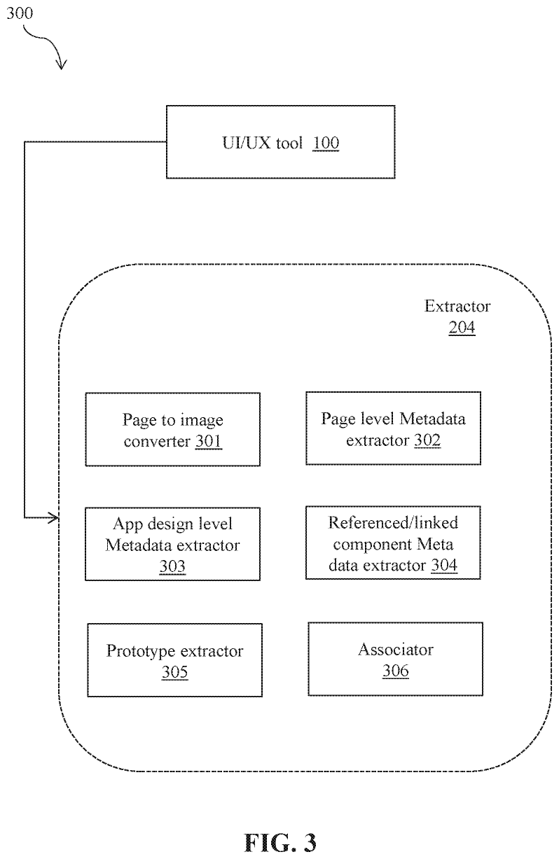

In one or more embodiments, the design target platform generation 203 may include one or more sub-modules, for example, an extractor 204, a parser 205, a detector 206, an analyzer 207, a transformer 208, a generator 209, and each module performs various operations, as described in conjunction with FIG. 3 to FIG. 6.

FIG. 3 illustrates one or more submodules 300 associated with the extractor 204, along with their corresponding functionalities, according to an embodiment of the present disclosure.

In one or more embodiments, the extractor 204 is a UI/UX tool native extension that can extract the metadata information in its native format. The extractor 204 can extract information from design system components from within the same design file or from referenced design files. The one or more submodules 300 may include a page-to-image converter 301, a page-level metadata extractor 302, an app design level metadata extractor 303, a referenced component metadata extractor 304, a prototype extractor 305, and an associator 306; and each submodule performs one or more operations/services, which are stated below.
a. Page-to-image converter 301: Each page is converted to an image, and these images are associated with the metadata information.
b. Page-level metadata extractor 302: The component extracts all parts of page design, including layouts, UI controls, styling information, and others.
c. App design level metadata extractor 303: Common configurations or settings across pages are maintained at the application level. The extractor captures at the application level.
d. Referenced component metadata extractor 304: Typically, the UI/UX design of an application is based on the design system or component library. The page designs make instances of these components. The extractor understands the referenced components and extracts their metadata as well.
e. Prototype extractor 305: The application simulation information is extracted from the page designs.
f. Associator 306: This correlates all the information above information like page design, with its corresponding page metadata, which is in turn linked with referenced component library metadata, then their prototyping information, and finally the application level metadata.

For instance, in the context of the page-to-image converter 301, a UI/UX designer creates multiple pages of an enterprise dashboard within the UI/UX design tool 100. Each page includes tables, charts, buttons, and navigation elements. The page-to-image converter 301 converts each page into a corresponding image representation. These image representations are stored along with the metadata extracted from the same pages. As a result, each visual representation of the dashboard page is directly associated with its originating design metadata, enabling subsequent image pattern analysis while preserving linkage to the underlying design structure.

For instance, in the context of the page-level metadata extractor 302, a page representing a user profile screen contains a header layout, form fields, action buttons, and style definitions. The page-level metadata extractor 302 analyzes the page design and extracts metadata describing the page layout structure, UI controls such as input fields and buttons, styling attributes such as font size and color, and alignment information. This extracted metadata provides a structured description of the page design, independent of how the page is visually rendered.

For instance, in the context of the App design level metadata extractor 303, in an application comprising multiple pages, common configurations such as a primary color theme, typography style, and grid layout are defined at the application level. For instance, all pages follow the same navigation bar structure and spacing rules. The app design level metadata extractor captures these shared configurations once at the application level, rather than repeatedly at the page level, thereby maintaining a centralized representation of application-wide design settings.

For instance, in the context of the referenced component metadata extractor 304, consider a scenario in which a login page uses a standard text input and button component sourced from a design system component library. The referenced component metadata extractor identifies that the page does not define these components locally but instead references predefined components. The referenced component metadata extractor 304 retrieves metadata associated with the referenced components, including default properties, supported states, and styling rules defined in the design system, and associates this metadata with the page where the components are instantiated.

For instance, in the context of the prototype extractor 305, in a prototype demonstrating user navigation, a button on a dashboard page links to a detailed report page. The prototype extractor 305 identifies this interaction by extracting application simulation information embedded within the design file, such as click actions, transition targets, and navigation flow definitions. This information enables the reconstruction of how a user progresses through different pages during application usage.

For instance, in the context of the associator 306, in a consolidated scenario, the associator 306 correlates the image generated for a page with its page-level metadata, links the extracted UI controls on the page to the corresponding referenced component metadata from the design system, and further associates prototype navigation information describing page-to-page transitions. Finally, the associator 306 connects all page-level information with application-level metadata, resulting in a unified and interconnected representation of page design, component usage, user interaction, and overall application configuration.

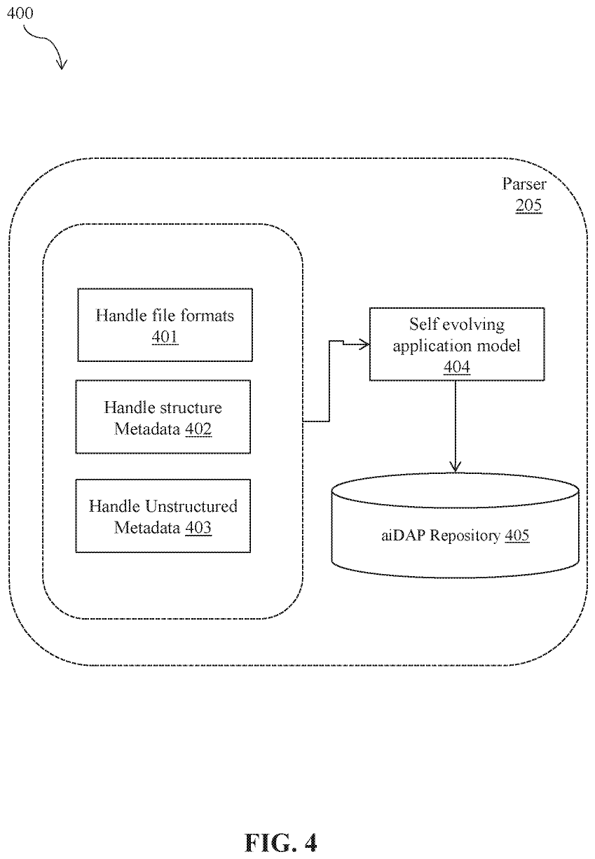

FIG. 4 illustrates one or more submodules 400 associated with the parser 205, along with their corresponding functionalities, according to an embodiment of the present disclosure. The parser 205 is configured to process raw metadata information obtained from UI/UX design tools 100 and translate such information into a self-evolving application model. The parser 205 is shown as a logical processing unit that operates on incoming design-related data originating from multiple UI/UX tools 100, each of which may store design information in proprietary formats and structures.

As depicted in FIG. 4, the parser 205 comprises multiple functional modules configured to handle different aspects of incoming metadata. A first module, designated as a file format handler 401, is configured to identify and manage various file formats associated with the incoming design data. In one or more embodiments, the file formats may correspond to proprietary formats used by different UI/UX tools, as well as standard or semi-structured formats. The file format handler 401 ensures that incoming data is interpreted correctly prior to further processing.

A second module, designated as a structured metadata handler 402, is configured to process metadata that conforms to a defined structural format. Such structured metadata may include information represented in formats such as JSON, XML, or other semi-structured representations that explicitly define elements, attributes, and relationships. The structured metadata handler 402 extracts relevant information from such representations and prepares it for subsequent model translation.

A third module, designated as an unstructured metadata handler 403, is configured to process metadata that does not conform to a predefined structure. This includes loosely organized or tool-specific metadata embedded within proprietary design files. The unstructured metadata handler 403 interprets and organizes such information so that it can be combined with structured metadata handled by the structured metadata handler 402.

The outputs of the file format handler 401, the structured metadata handler 402, and the unstructured metadata handler 403 are provided to a model translation component configured to generate a self-evolving application model 404. The self-evolving application model 404 represents an ML understandable representation of the application design derived from the raw metadata information. This model is capable of incorporating design information originating from different UI/UX tools and formats in a unified manner.

As further shown in FIG. 4, the self-evolving application model 404 is stored and maintained within an Aiden Digital Acceleration Platform (aiDAP) repository 405. The aiDAP repository 405 serves as a centralized storage for the translated application model and enables persistence and reuse of the processed design information. The association between the parser 205, the self-evolving application model 404, and the aiDAP repository 405 enables seamless integration and manipulation of metadata irrespective of its original format or source.

For instance, a designer may create application screens using a first UI/UX design tool that stores design information in a proprietary binary format, while additional screens are created using a second tool that exports metadata in JSON format. The parser 205 receives both inputs, identifies their respective file formats using the file format handler 401, processes structured metadata using the structured metadata handler 402, and interprets unstructured proprietary metadata using the unstructured metadata handler 403. The extracted information is translated into a unified self-evolving application model 404, which is stored in the aiDAP repository 405 for further processing or analysis.

The configuration illustrated in FIG. 4 enables consistent translation of heterogeneous and proprietary UI/UX design metadata into a unified self-evolving application model. By accommodating multiple file formats and metadata structures, the parser 205 provides versatility and robustness in processing design information from diverse sources. This architecture supports seamless integration, unified interpretation, and centralized storage of application design metadata irrespective of the original UI/UX tool or representation format.

In one or more embodiments, the self-evolving application model 404 utilized by the parser is described in U.S. Pat. No. 12,561,118 B2, issued on Feb. 24, 2026, and entitled “System and Method for Automated Technology Migration,” assigned to AidenAi, Inc. As the referenced U.S. patent has been granted and is not co pending, self-evolving application model 404 is referenced as a related patent, the disclosure of which is incorporated herein by reference for all purposes consistent with the present disclosure.

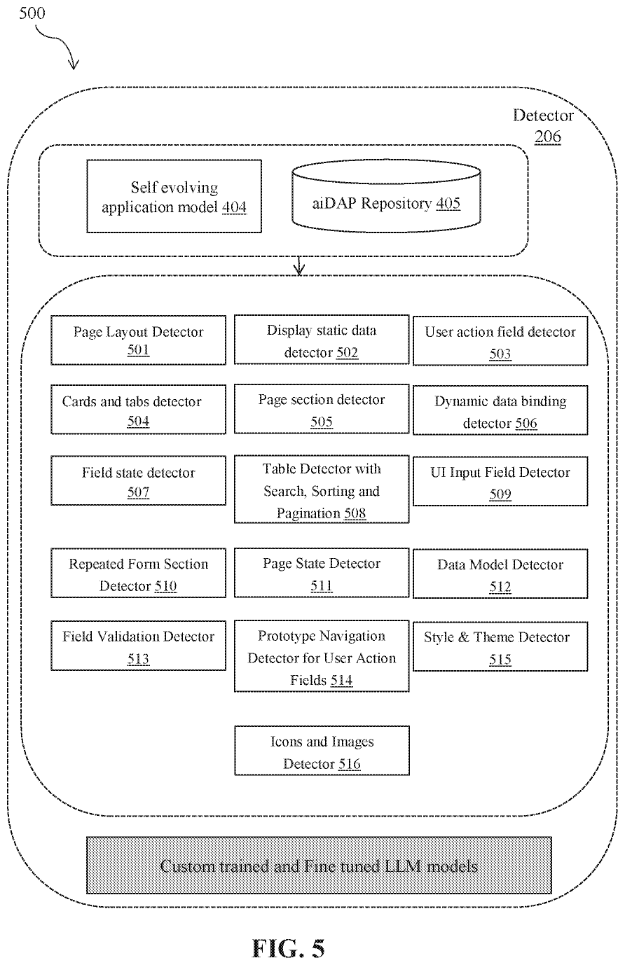

FIG. 5 illustrates one or more submodules 500 associated with the detector 206, along with their corresponding functionalities, according to an embodiment of the present disclosure.

The detector 206 functions as a primary analytical module that correlates information obtained from a design system component library, page design files, and images extracted from page designs to derive a structured understanding of the UI/UX design. The detector 206 enables segmentation of visual and structural information and relates detected elements to determine attributes, including layouts, UI components, styles, relationships between components, data models, and navigation behaviors.

As shown in FIG. 5, the detector 206 receives normalized design information from the self-evolving application model 404 and the aiDAP repository 405. Using these inputs, the detector 206 applies a multi layered classification (e.g., a triple-layered classification methodology). In a first layer, image pattern analysis is performed on page images to identify distinct parts of the design. In a second layer, spatial relationships between the identified parts are determined using positional attributes, including x coordinates, y coordinates, height, and width. In a third layer, the initial classification results are verified and refined by comparing image-based classification with page-level metadata and further validating against metadata present in the design system or component library, after which the detector 206 re-classifies the design parts.

The detector 206 comprises one or more submodules 500, each configured to detect specific attributes of the page design, for example:
a. A page layout detector 501 identifies container components, their styles, spatial coordinates, and hierarchical relationships to determine the overall layout of a page.
b. A display static data detector 502 analyzes text and labels present on the page, together with positional, parent-child, and sibling relationships, to classify static display content.
c. A user action field detector 503 identifies UI components that are user actionable, including buttons, links, icons, and related interactive elements.
d. A cards and tabs detector 504 applies pattern recognition and spatial relationship analysis to classify sections as cards or components as tabs.
e. A page section detector 505 receives the identified containers and classifies them into logical sections based on the child components contained therein.
f. A dynamic data binding detector 506 further processes classified text elements to determine whether the data is static or dynamically bound, thereby ensuring accurate distinction between static and dynamic data through a double detection mechanism.
g. A field state detector 507 identifies different states of UI components, including primary, secondary, disabled, focused, and similar states.
h. A table detector with search, sorting, and pagination 508 identifies tabular components and associated features, including search functionality, sorting capability, and pagination controls.
i. A UI input field detector 509 classifies parts or containers as input fields, including text fields, dropdowns, date pickers, checkboxes, text areas, and similar UI elements, and assigns scores to such classifications.
j. A repeated form section detector 510 identifies repeated form structures by performing section pattern matching while ignoring dynamic data and retaining relative positioning, field classifications, and static and dynamic data classifications.
k. A page state detector 511 identifies section-level or page-level states, including read-only, collapsed, minimized, and other page or section states.
l. A data model detector 512 derives a data model of the page based on identified input fields and dynamic data binding components, including field types, formats, and attributes.
m. A field validation detector 513 analyzes detected input fields to determine associated validation characteristics such as mandatory fields, number formats, date formats, currency formats, and other validation constraints.
n. A prototype navigation detector 514 extracts application simulation and routing information based on detected user actions and preserves such navigation relationships for further processing.
o. A style and theme detector 515 extracts styling attributes and derives themes from current page designs, application-level metadata, and design system-level metadata.
p. An icons and images detector 516 identifies icons, images, and logos by comparing binary metadata and positional data with trained models.

A reconciler (part of submodules 500, not shown in FIG. 5) maintains consistency when page designs are revised by aligning updated design information with previously detected and classified elements.

In one or more embodiments, the reconciler is configured to maintain a versioned representation of previously generated target platform outputs. The versioned representation enables systematic tracking of successive generations of the target platform outputs over time. Upon receiving an updated UI/UX design, the reconciler is configured to initiate a comparison process between the updated UI/UX design and the previously generated target platform outputs. Such comparison is performed at the level of individual classified elements, thereby enabling granular identification of changes across corresponding elements.

In one or more embodiments, the reconciler is configured to detect changes at the individual element level and to assign a weightage to each detected change. The assigned weightage is determined based on the nature, scope, and type of the modification. The weightage reflects the relative significance of the detected change with respect to the overall page structure and functional behavior of the target platform outputs, thereby enabling differentiated handling of changes having varying impacts.

In one or more embodiments, the reconciler is further configured to classify each detected change along two dimensions. In a first dimension, the reconciler classifies the origin of the change. The origin classification includes (a) user changes, comprising modifications made by developers or configurators to the previously generated target platform outputs, and (b) system changes, comprising modifications resulting from updated UI/UX designs processed through a transformation pipeline. This origin-based classification establishes whether a detected change originates from user-driven activity or from system-driven design updates.

In a second dimension, the reconciler is configured to classify the type of each detected change into one or more predefined categories. The predefined categories include: (i) UI design changes, comprising modifications to page layout, component placement, section structure, and navigation hierarchy; (ii) UI style changes, comprising modifications to colors, fonts, spacing, themes, and visual styling attributes; (iii) backend integration changes, comprising modifications to API bindings, data source configurations, and service connectors; (iv) business logic changes, comprising modifications to conditional rules, workflow sequences, and data transformations; and (v) validation changes, comprising modifications to field validation rules, data format constraints, and mandatory field designations. The type-based classification enables structured differentiation among visual, functional, and validation-related modifications.

In one or more embodiments, the reconciler is configured to apply a preference policy based on the origin classification, the change type classification, and the assigned weightage. The preference policy is configured such that, for UI design changes and UI style changes, an updated UI/UX design received from a design tool takes precedence. Conversely, for backend integration changes, business logic changes, and validation changes, user or developer modifications take precedence. This configuration ensures that implementation-level configurations are retained and are not overwritten by design updates. The preference policy may be adjusted through configuration parameters based on project-specific requirements.

In one or more embodiments, when the applied preference policy is unable to resolve a detected conflict, the reconciler is configured to flag the conflict and present the conflict to a user for manual review. The presented information includes an original generated element, a user-modified version, and a system-generated version, along with the assigned weightage and associated classifications, thereby enabling informed resolution by the user.

In one or more embodiments, the reconciler is configured to register outcomes of conflict resolutions and to utilize the registered outcomes as training inputs for machine learning models. The machine learning models are configured to improve future reconciliation decisions based on the registered outcomes.

Over successive reconciliation cycles, the system is configured to learn from accumulated resolution patterns to automatically resolve similar conflicts. As a result, the frequency of user-facing conflicts is progressively reduced while ensuring that developer contributions are preserved.

For instance, a UI/UX designer creates multiple screens of an enterprise application using a design system-based UI/UX tool. Page images and associated metadata are stored in the aiDAP repository 405 and normalized through the self-evolving application model 404. The detector 206 analyzes the designs to identify layout containers using the page layout detector 501, classifies form sections using the page section detector 505, identifies input fields and validation rules using the UI input field detector 509 and field validation detector 513, and extracts navigation flows through the prototype navigation detector 514. The resulting classifications are validated against the design system metadata to refine accuracy.

The detector architecture 500 illustrated in FIG. 5 enables accurate and consistent classification of UI/UX designs by correlating image-based analysis with page-level and design system-level metadata using a triple-layered methodology. The use of specialized detectors 501-516 allows granular identification of layout, interaction, state, and data attributes, thereby reducing ambiguity and improving the reliability of UI/UX design interpretation across heterogeneous tools and formats.

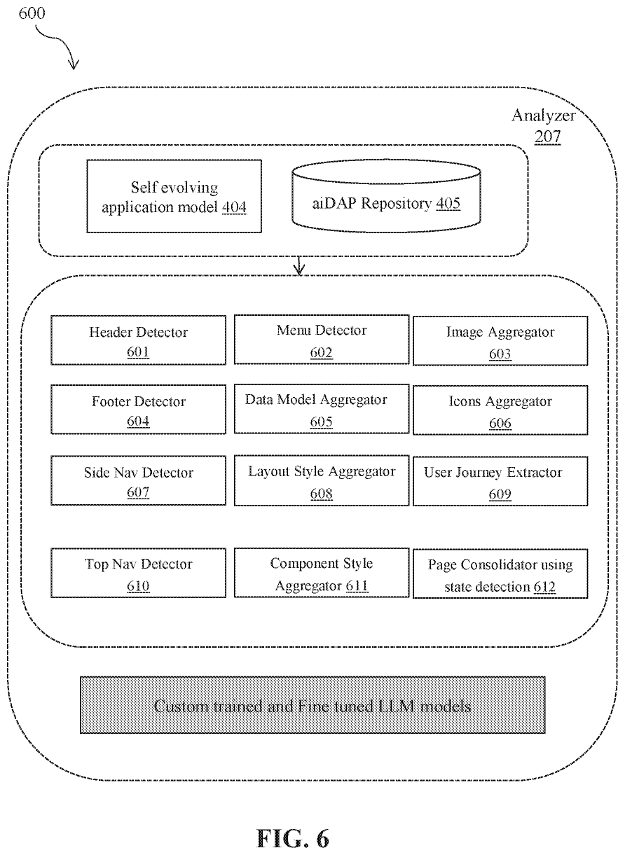

FIG. 6 illustrates one or more submodules 600 associated with the analyzer 207, along with their corresponding functionalities, according to an embodiment of the present disclosure. The analyzer 207 operates on outputs generated by prior classification and page design detection and performs higher-level analysis across multiple pages to enrich detected information. The analyzer 207 correlates information obtained from the self-evolving application model 404 and the aiDAP repository 405 to identify reusable structures, consolidate page variations, and aggregate shared design assets across an application.

As shown in FIG. 6, the analyzer 207 performs across-page level analysis by applying pattern matching and positional analysis to determine the type of sections present within different page designs and to identify reusability of such sections across pages. Based on this analysis, the analyzer 207 detects reusable components, including headers, footers, side navigation, top navigation, menus, popups, and other reusable sections that recur with similar structure and positioning across multiple pages of the application.

The analyzer 207 includes one or more submodules 600, each responsible for aggregating and enriching specific types of information. A header detector 601 identifies header sections that appear consistently across pages, while a footer detector 604 identifies footer sections with recurring layout and content. A side navigation detector 607 and a top navigation detector 610 extract navigation structures positioned along the side or top regions of pages.

A menu detector 602 identifies menu components, including nested or expandable menu structures, based on positional and relational analysis. An image aggregator 603 and an icons aggregator 606 collect and form aggregated sets of images, icons, and graphical assets used across different pages of the application. These aggregated collections represent common visual resources that can be reused during transformation to the target platform 211.

A data model aggregator 605 consolidates data model information detected across multiple pages, enabling unified representation of data fields and relationships used throughout the application. A layout style aggregator 608 aggregates layout styles applied across pages, while a component style aggregator 611 aggregates styling attributes associated with reusable components, enabling consistent style application during transformation.

A user journey extractor 609 derives user journeys by analyzing navigation flows and page transitions detected across pages, thereby identifying common paths taken by different personas. A page consolidator using state detection 612 performs page consolidation by identifying cases where the same logical page is represented multiple times in the UI design for different personas or different states. The analyzer 207 detects such variations and combines the possible representations into a single consolidated page for transformation to the target platform 211.

As illustrated, the analyzer 207 operates in conjunction with custom-trained and fine-tuned language models to enhance pattern recognition and aggregation accuracy. Based on the classification and page design detection, the analyzer 207 may gather and arrive at additional information that helps in the automation of the page transformation to the target platform 211.

For instance, an enterprise application may include multiple dashboard pages that differ slightly based on user roles, such as an administrator view and a standard user view. The analyzer 207 detects that these pages share a common header, footer, side navigation, and overall layout structure using the header detector 601, footer detector 604, and side navigation detector 607. Icons and images used across these pages are aggregated using the image aggregator 603 and the icons aggregator 606. The page consolidator using state detection 612 identifies that differences between the pages correspond to role-based states and consolidates the multiple page designs into a single page representation suitable for transformation to the target platform 211.

The analyzer architecture 600 illustrated in FIG. 6 enables efficient automation of page transformation by enriching detected design information through across-page analysis. By identifying reusable sections, aggregating shared visual assets, and consolidating page variations representing different personas or states, the analyzer 207 reduces redundancy in page definitions and ensures consistency during transformation. This structured aggregation facilitates accurate and scalable transformation of complex UI/UX designs to target platforms (e.g., target platform 211) while preserving design intent across the application.

In the context of the high-level view of the transformation of application design into the target platform 211, based on the outcome of detectors and analyzer services, the transformer 208 is capable of creating outputs compatible with the target platform 211. The target platform 211 is broadly classified into two categories, which are mentioned below.
a. Low-code/no-code platforms: Due to the lack of configurations available in the public domain and each product having a proprietary format, the tools available in the existing system cannot produce the configurations specific to these platforms. Our inventions are trained and fine-tuned to understand those platforms and produce efficient outcomes.
b. Open-source frameworks: The transformer is fine-tuned to understand the target framework component libraries and their styling mechanism. Since the invention had already been detected and classified the designs with better efficiency, the transform used this information and transformed to target framework-specific components instead of mere HTML tags.

In the context of the high-level view of the transformation of application design into the target platform 211, push the generated configuration and code to the target platform 211. The generator 209 is trained against prominent low code/no code platforms and open-source frameworks. This direct integration to the target platform 211 enables real-time transformation of the design to the target platform 211.

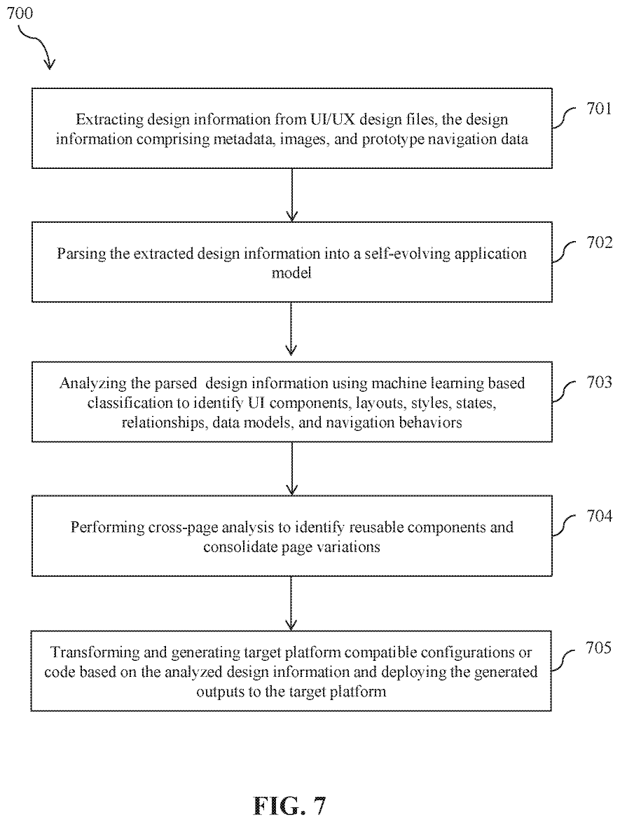

FIG. 7 is a flow diagram illustrating a method 700 for transforming the at least one of UI design or UX design into the target platform outputs, according to an embodiment of the present disclosure. The method 700 may execute multiple steps for transforming the at least one of UI design or UX design into the target platform outputs (e.g., target platform 211).

At step 701, the method 700 includes extracting design information from UI/UX design files, the design information comprising metadata, images, and prototype navigation data. At step 702, the method 700 includes parsing the extracted design information into the self-evolving application model 404. At step 703, the method 700 includes analyzing the parsed design information using machine learning based classification to identify UI components, layouts, styles, states, relationships, data models, and navigation behaviors At step 704, the method 700 includes performing cross-page analysis to identify reusable components and consolidate page variations. At step 705, the method 700 includes transforming and generating target platform compatible configurations or code, based on the analyzed design information and the cross-page analysis, and deploying the generated outputs to the target platform 211. Further, a detailed description related to the various steps of FIG. 7 is covered in the description related to FIG. 2 to FIG. 6 and FIGS. 8A-8E and is omitted herein for the sake of brevity.

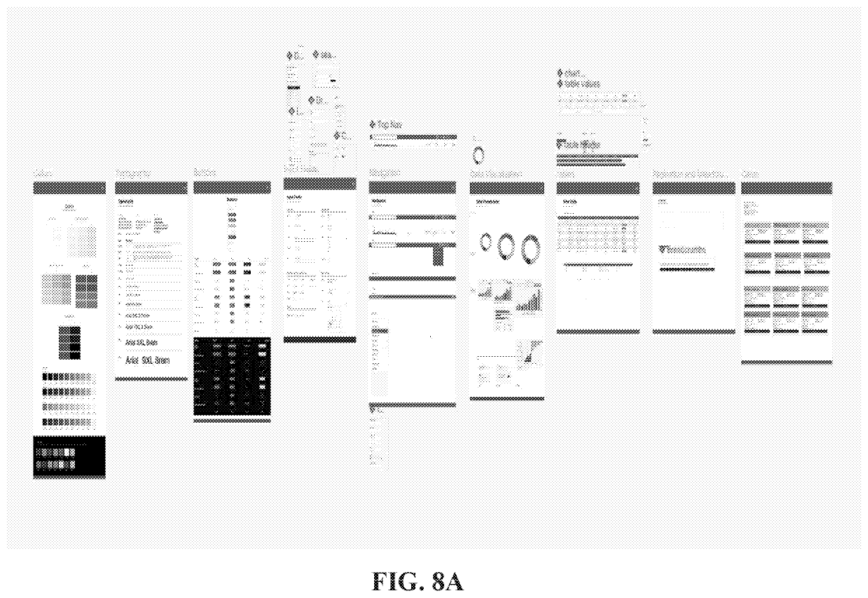

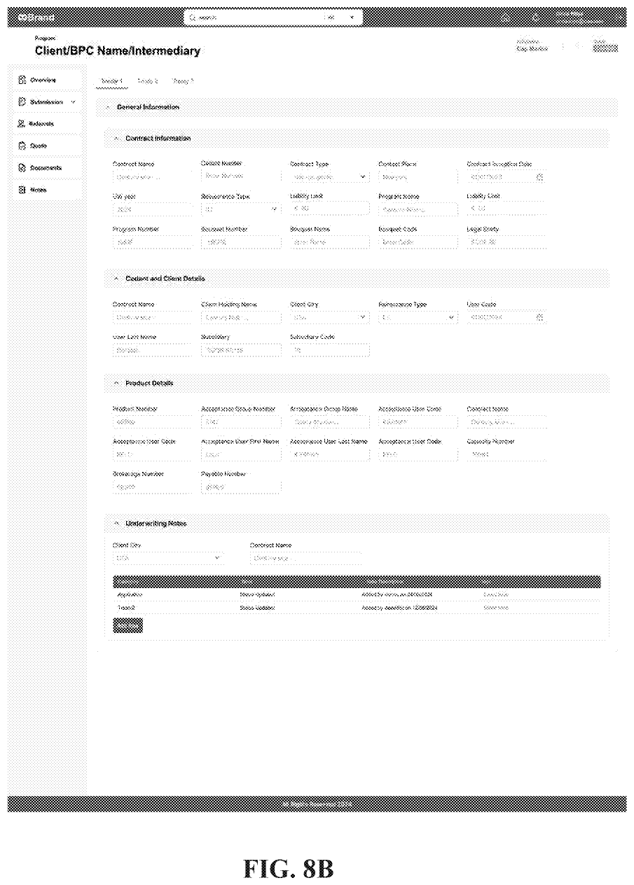

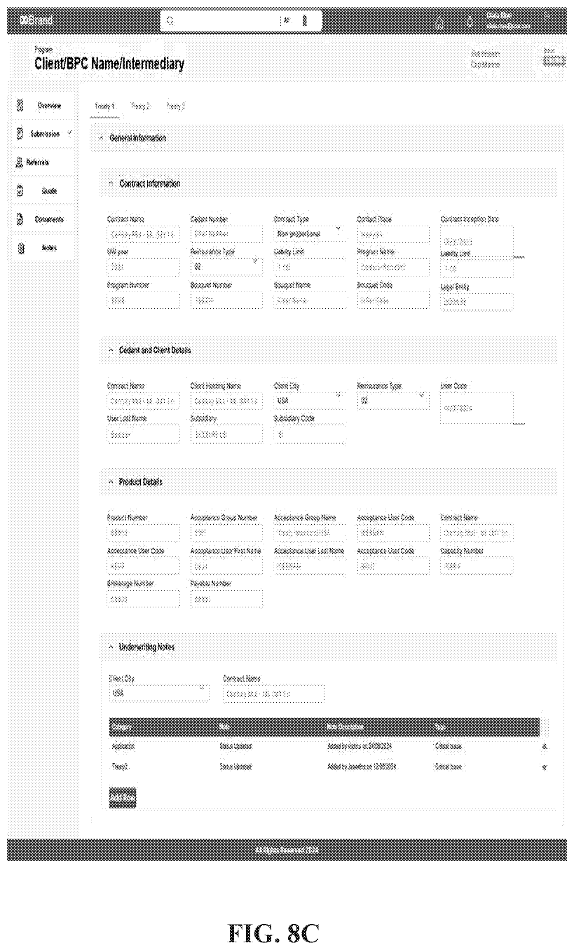

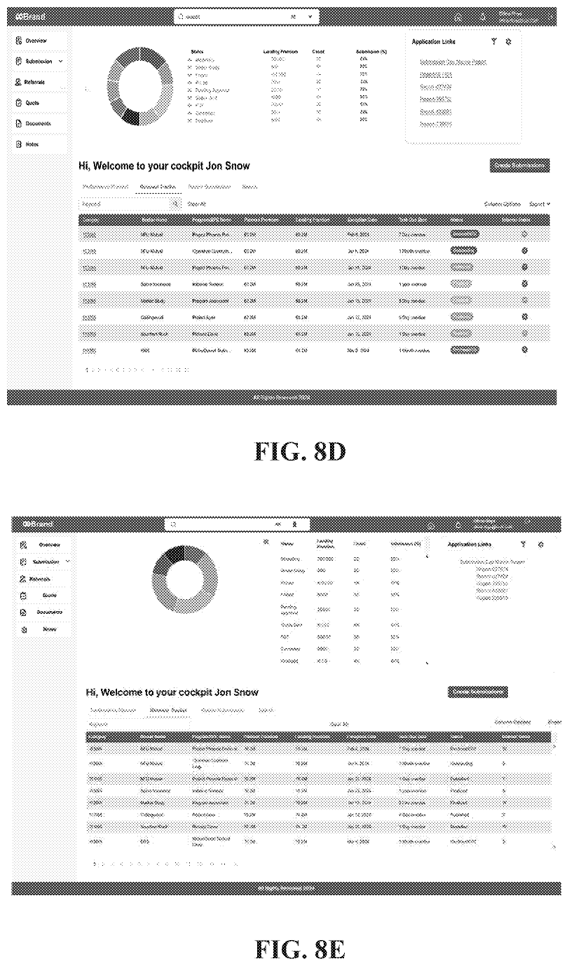

FIGS. 8A-8E illustrates an exemplary scenario transforming UX designs into code using the ML model, according to an embodiment of the present disclosure. In other words, FIGS. 8A-8E illustrates working examples and complete data illustrating the operation of a system for transforming UI and UX designs into configurations compatible with the low code or no code platform. The working examples demonstrate an end-to-end transformation pipeline in which UI/UX designs created using a design tool are automatically processed and converted into executable configurations for deployment on the target platform 211. The examples are provided as an addendum to a non-provisional patent specification and are intended to validate the functionality and technical feasibility of the disclosed system.

The working examples illustrate the interaction and operation of multiple system components, including the extractor 204 for metadata extraction, the parser 205 for translating extracted information into the self-evolving application model 404, the detector 206 implementing the triple-layered classification methodology, the analyzer 207 performing cross-page analysis, the transformer 208 for generating target platform configurations, and the generator 209 for deployment to the low code or no code platform.

Design system and component definitions, as shown in FIG. 8A, the working examples utilize a design system defined within the UI/UX design tool 100. The design system includes a reusable component library comprising visual and functional definitions for common UI elements. The design system defines standardized colors, typography, buttons, input fields, navigation components, data visualization components, tables, pagination elements, breadcrumbs, and card layouts.

The system extracts and analyzes design system metadata to identify reusable components and their attributes. The design system metadata includes component definitions, styling rules, and state variations. These definitions are subsequently referenced during classification and transformation to ensure consistency between the source design and the generated target platform output (e.g., target platform 211).

TABLE 1
Design system component categories

| Component | |
|---|---|
| category | Components included |
| Colors | Primary (#0080A9), Secondary, Neutral scales, |
| | Status colors |
| Typography | Arial font family, sizes from 3XL to 9XL |
| | (3 rem to 8 rem) |
| Buttons | Primary, Secondary, Outlined, Link buttons with |
| | states (default, hover, focus, disabled) |
| Input Fields | Text input, Dropdown, Date picker, Checkbox, |
| | Text area, Search field |
| Navigation | Top navigation bar, Side navigation menu, Tabs, |
| | Breadcrumbs |
| Data | Donut charts, Bar charts, and Summary statistics |
| Visualization | |
| Tables | Data tables with header styling, sorting, pagination, |
| | search, and column options |

Working Example 1: Treaty form screen transformation (e.g., Figma® to Unqork®), a first working example demonstrates the transformation of a treaty form screen from a UI/UX design tool to a low code or no code platform configuration, refer to FIGS. 8B-8C. The source design comprises multiple collapsible sections, including general information, contact information, cedent and client details, product details, and underwriting notes. The screen further includes multiple input fields, tables, and user-action elements.

The extractor 204 extracts metadata from the design file, including component hierarchy, positional coordinates, layout properties, styling attributes, text content, and references to design system components. The parser 205 converts this extracted information into a self-evolving application model 404. The detector 206 applies the triple-layered classification technique to identify the page layout, logical sections, input fields, tables, user-action elements, and navigation components. The detector 206 first performs image pattern analysis, correlates spatial metadata using positional attributes, and verifies classifications against design system metadata.

The transformer 208 converts the classified elements into target platform configuration components while preserving layout hierarchy, styling, and navigation behavior. The generator 209 deploys the generated configuration to the target platform 211, resulting in a functional representation of the original design.

TABLE 2
Detection Results - Treaty Form Screen

| Detector Type | Count | Detected Elements |
|---|---|---|
| Page layout detector | 1 | Sidebar + Main Content layout |
| Page section detector | 5 | General Info, Contract Info, |
| | | Cedent/Client, Product Details, |
| | | Underwriting Notes |
| UI input field detector | 28 | Text fields, dropdowns, date pickers |
| Table detector | 2 | Underwriting Notes table, Section |
| | | Details table |
| User action detector | 3 | Add Row button, Tab navigation |
| | | buttons |
| Navigation detector | 6 | Overview, Submission, Referrals, |
| | | Quote, Documents, Notes |

Working example 2: treaty dashboard screen transformation (e.g., Figma® to Unqork®), a second working example demonstrates transformation of a treaty dashboard screen, refer to FIGS. 8D-8E. The dashboard includes data visualization components, summary statistics, tabbed navigation views, and a data table with pagination, sorting, and search capabilities.

The extractor 204 retrieves structured metadata describing chart components, card layouts, tab containers, and table elements. The detector 206 identifies data visualization components, cards, tabs, tables, and associated user actions. The analyzer 207 performs cross-page analysis to identify reusable elements and shared navigation structures. The transformed configuration preserves functional relationships, visual styling, and user interactions present in the original design and is deployed to the target platform 211.

TABLE 3
Detection results - treaty dashboard screen

| Detector Type | Count | Detected Elements |
|---|---|---|
| Data visualization | 1 | Donut chart with status breakdown |
| detector | | |
| Cards detector | 1 | Application Links card panel |
| Tabs detector | 4 | Performance Planned, Renewal |
| | | Tracker, Recent Submissions, Search |
| Table detector | 1 | Data table with 9 columns, |
| | | pagination (15 pages) |
| User action detector | 4 | Create Submissions, Column |
| | | Options, Export, Clear All |

Input metadata structure: the input design metadata extracted from the design tool is structured and hierarchical. The metadata includes component identifiers (e.g., FRAME, GROUP, TEXT, VECTOR, RECTANGLE, etc.), bounding box coordinates (x, y, width, height), layout properties (layout Mode, padding, alignment), styling attributes (e.g., fills, strokes, effects, fonts), and component references. The metadata captures both structural and visual aspects of the design and serves as the basis for classification and transformation.

The following is an excerpt from the extracted Figma metadata showing the hierarchical structure. For complete data, refer to attached files: FIgma_screenjson_for_dahbord_and_form.json and FigmaComponentdataScreen.json.

TABLE 4
Sample Input JSON (Figma Metadata)

| { | “id”: “14:23625”, | “name”: “ Treaty |
|---|---|---|
| dashboard V1”, | | “type”: “FRAME”, |
| “scrollBehavior”: “SCROLLS”, | | “children”: |
| [ | { | “id”: “49:5273”, |
| “name”: “Top Nav”, | | “type”: “FRAME”, |
| “scrollBehavior”: “SCROLLS”, | | “children”: |
| [ | { | “id”: “54:129481”, |

| | |
|---|---|
| “name”: “Frame 1000002935”, | “type”: “FRAME”, |
| “scrollBehavior”: “SCROLLS”, | “children”: |

| | | |
|---|---|---|
| [ | { | “id”: |

| | |
|---|---|
| “58:198563”, | “name”: “Vector”, |
| “type”: “VECTOR”, | “scrollBehavior”: |
| “SCROLLS”, | “blendMode”: “PASS_THROUGH”, |

| | “fills”: | |
|---|---|---|
| [ | { | “blen |

| | |
|---|---|
| dMode”: “NORMAL”, | “type”: “SOLID”, |
| “color”: { | “r”: 1.0, |
| “g”: 1.0, | “b”: 1.0, |

| | “a”: | |
|---|---|---|
| 1.0 | } | } |

| | |
|---|---|
| ], | “strokes”: [ ], |

“strokeWeight ... [EXCERPT - SEE ATTACHED JSON FILE FOR COMPLETE

DATA]

Output configuration structure (e.g., UNQORK CONFIGURATION), the generated output is a target platform-compatible configuration file. The configuration includes component definitions (panel, field-group, button, htmlelement, textfield, dropdown, etc.), hierarchical relationships, custom styling classes (styleaClassName), event handlers (clickTrigger, event), navigation rules, and table configurations. Ancestor tracking is preserved to ensure correct component nesting.

The following is an excerpt from the generated Unqork configuration. For complete data, refer to attached files: TreatyForm-Unqork.json and TreatyDashboard-Unqork.json.

TABLE 5
Sample Output JSON (Unqork Configuration)

[{“components”:[{“components”:[{“components”:[{“rightIcon”:“”,“doNotShowValid
atedPopup”:true,“leftIcon”:“”,“type”:“button”,“disableOnInvalid”:false,“cancelButton
”:“Cancel”,“errorTitle”:“Oops - {{ errors }} error(s) have been
found!”,“permissions”:[ ],“action”:“event”,“block”:false,“oneClickOnly”:false,“theme”
:“link”,“persistent”:false,“ancestors”:[“root”,“TreatformUPG”,“TopNav”,“TopNavFG
”],“event”:“event Treat dashboard UPG”,“key”:“brand4”,“errorMessage”:“Please
check your module and fix fields outlined in
red”,“tableView”:false,“label”:“”,“successMessage”:“Success!”,“successValidateMess
age”:“Success!”,“input”:true,“confirmationButton”:“OK”,“size”:“md”,“customClass”:

| | |
|---|---|
| “styleabrand4”,“elementType”:“module”,“clickTrigger”:“ruleTreat | form |

UPG”,“componentId”:“f3770844-6460-4895-a6a3-
68dcc919b17a”},{“components”:[{“components”:[{“components”:[{“components”:[{
“components”:[{“components”:[{“components”:[{“components”:[{“rightIcon”:“”,“do
NotShowValidatedPopup”:true,“leftIcon”:“”,“type”:“button”,“disableOnInvalid”:false
,“cancelButton”:“Cancel”,“errorTitle”:“Oops - {{ errors }} error(s) have been
found!”,“permissions”:[ ],“action”:“”,“block”:false,“oneClickOnly”:false,“theme”:“link
”,“persistent”:false,“ancestors”:[“root”,“TreatformUPG”,“TopNav”,“TopNavFG”,“Fra
me759791095”,“Frame759791095FG”,“search”,“searchFG”,“Input”,“InputFG”,“Cont
ent”,“ContentFG”],“key”:“searchlg4”,“errorMessage”:“Please check your module and

| | | | |
|---|---|---|---|
| fix | fields | outlined | in |

red”,“tableView”:false,“label”:“”,“successMessage”:“Success!”,“successValidateMess
age”:“Success!”,“input”:true,“confirmationButton”:“OK”,“size”:“md”,“customClass”:
“styleasearchlg4”,“elementType”:“module”,“componentId”:“570fbaa7-f097-4840-
8bdb-
5abbe1aed0be”}],“breadcrumb”:“default”,“form”:“5965560469ba110011b394d9”,“pe
rmissions”:“”,“collapsed”:false,“customClass”:“grid-
container”,“label”:“”,“type”:“field-
group”,“ancestors”:[“root”,“TreatformUPG”,“TopNav”,“TopNavFG”,“Frame7597910
95”,“Frame759791095FG”,“search”,“searchFG”,“Input”,“InputFG”,“Content”],“paren
tChanged”:true,“key”:“ContentFG”,“wasDropped”:true,“componentId”:“0c8feb48-
3ed6-4daa-b257-
0fbaa7f09758”}],“tableView”:false,“label”:“”,“type”:“panel”,“title”:“”,“imageStyle”:“
”,“outsideDismiss”:true,“input”:false,“permissions”:“”,“customClass”:”styleaContent-
TreatformUPG”,“theme”:“default”,“ancestors”:[“root”,“TreatformUPG”,“TopNav”,“T
opNavFG”,“Frame759791095”,“Frame759791095FG”,“search”,“searchFG”,“Input”,“
InputFG”],“key”:“Content”,“modal”:false,“componentId”:“962a0c8f-eb48-4ed6-8daa-
f2570 ... [EXCERPT - SEE ATTACHED JSON FILE FOR COMPLETE DATA]

In transformation mapping, the system performs explicit mapping between design elements and target platform components. This mapping ensures a faithful transformation of design intent into executable configurations.

TABLE 6
Transformation Mapping

| Design Element | Design Type | Target Component |
|---|---|---|
| Page Container | FRAME (root) | panel (type: panel) |
| Section | FRAME (nested) | field-group |
| Text Input | Input Fields | textfield |
| | component | |
| Dropdown | Dropdown component | dropdown |
| Date Picker | Date field | datetime |
| | component | |
| Button | Buttons component | button (theme: primary/link) |
| Static Text | TEXT | htmlelement (tag: span) |
| Data Table | Tables component | datagrid with jsgrid styles |
| Navigation Link | Prototype | decision (rulePage navigation) |
| | interaction | |

The working examples demonstrate the complete transformation pipeline from UI/UX designs to low code or no code platform configurations. The examples validate the system's ability to extract metadata, classify design elements using a triple-layered technique, analyze reusable and cross-page patterns, and generate executable configurations that preserve layout, styling, and navigation behavior. The disclosed working examples confirm that complex UI constructs such as forms, dashboards, tables, and charts can be accurately transformed and deployed using the disclosed system.

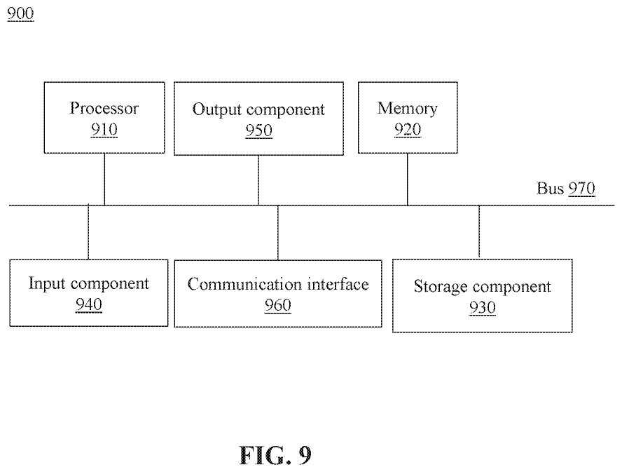

FIG. 9 illustrates a diagram of example components of an apparatus 900, according to an embodiment of the present disclosure. As shown in FIG. 9, the apparatus 900 comprises a processor 910, a memory 920, a storage component 930, an input component 940, an output component 950, a communication interface 960, and a bus 970. In one embodiment, the apparatus 900 may relate to at least one of the units or modules as shown in FIG. 2 to FIG. 6.

The processor 910, as used herein, means any type of computational circuit that may comprise hardware elements and software elements. The processor 910 may be embodied as a multi-core processor, a single core processor, or a combination of one or more multi-core processors and/or one or more single core processors, a distributed processing system, or the like. The processor 910 may be a central processing unit (CPU), a graphics processing unit (GPU), an accelerated processing unit (APU), an application-specific integrated circuit (ASIC), or another type of processing component.

The memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions, when executed by the processor 910 cause the processor 910 to perform one or more method steps of an embodiment described above.

The storage component 930 stores information and/or software related to the operation and use of the apparatus 900. For example, the storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 940 is configured to receive information, such as user input. For example, the input component 940 may include, but not be limited to, a touchscreen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

The output component 950 is configured to provide output information from the apparatus 900. For example, the output component 950 may be, but is not limited to, a display, a speaker, instructions to an external device, and/or one or more light-emitting diodes (LEDs).

The communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the apparatus 900 and other devices. In other words, the standard of the communication interface 960 is not limited.

The bus 970 acts as an interconnect between the processor 910, the memory 920, the storage component 930, the input component 940, the output component 950, and the communication interface 960 of the apparatus 900. The bus 970 may include a wired interconnection or a wireless interconnection.

The number and arrangement of components shown in FIG. 9 are provided as an example. In practice, the apparatus 900 may include additional components, fewer components, different components, or differently arranged components than those shown in FIG. 9. Additionally, or alternatively, a set of components (e.g., one or more components) of the apparatus 900 may perform one or more functions described as being performed by another set of components of the apparatus 900. Further, one or more method steps described in any of the embodiments may be performed utilizing the apparatus 900 in communication with one another.

The method/system has several advantages over the existing method, which are stated below.
a. The existing tools cannot transform the designs into configurations and deploy them to low code/no code platforms. The disclosed method/system, capable of understanding the proprietary formats of low code platforms, transforms the designs into configurations compatible with the platform.
b. No tool in the existing system detects the data model and its specifications from the UI/UX design. The disclosed method/system detects the input fields and classifies the input fields into the corresponding components, like a number, date, currency, text, text area, single-select dropdown, and multi-select dropdown, with their values. Not only that, but it can also detect the data formats as well from the design and create validation rules as part of the data model.
c. The tools in the existing system create target code as a set of HTML divs (<div/>) and simple input fields rather than open-source UI framework-specific components. The disclosed method/system understands the target framework and creates framework-specific components instead of mere HTML tags.
d. The tools in the existing system cannot create the screen flows and workflows from the design prototyping or the application simulation. The disclosed method/system can detect the routing rules and transform them into screen flows/workflows in the target platform 211.
e. The tools work as fresh code generation and do not have the intelligence to detect the existing code updated by the developers. But in real-time scenarios, most of the time, designs are updated in parallel with development. So, making fresh code will force the developers to redo the earlier work manually. The disclosed method/system has a unique reconciliation feature to automatically detect user changes with the updated UI/UX design, so it retains the existing work done by developers from the earlier code generation.
f. The tools in the existing system cannot identify the personas and user journeys based on application requirements. The disclosed method/system can detect the personas and user journeys from the requirement, along with creating better user interactions and suggesting creative high-fidelity UI designs. Overall, this feature enables designers to create a better user experience for the application requirements.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device or a combination of hardware devices and software modules.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A system for transforming at least one of User Interface (UI) design or User Experience (UX) design into target platform outputs, the system comprising:
at least one processor and a memory storing executable instructions, wherein at least one processor is configured to:
extract design information from one or more UI/UX design files, wherein the design information comprising at least one of page level metadata, application level metadata, referenced component metadata, image representations, and prototype navigation information;
parse the extracted design information into a self-evolving application model;
analyze the parsed design information using machine learning-based classification to identify at least one of UI components, layouts, styles, states, relationships, data models, and navigational behaviors;
perform cross-page analysis to identify reusable components and consolidate page variations; and
transform and generate target platform compatible outputs based on the analyzed design information and the cross-page analysis, wherein the outputs are deployable to at least one low code/no code platform or open source UI framework.

2. The system as claimed in claim 1, wherein to transform and generate the target platform compatible outputs, the at least one processor is configured to:
invoke a sequence of machine learning services to convert analyzed UI/UX designs into configurations or code formats compliant with proprietary specifications of the target platform,
wherein the target platform comprises a low code/no code platform with proprietary configuration formats or an open source UI framework with framework specific components or libraries.

3. The system as claimed in claim 1, wherein to extract design information, the at least one processor is configured to:
extract page level metadata from one or more UI/UX design files, wherein the page level metadata represents layout structures, UI elements, and styling attributes of individual pages;
convert each page into a corresponding image representation, wherein the image representation is logically linked to the extracted page level metadata for coordinated analysis;
extract application level configurations, wherein the application level configurations represent common settings and properties applicable across multiple pages of the application;
extract metadata associated with referenced design system components, wherein the referenced design system components are instantiated within the pages and defined in the same or externally referenced design files;
extract prototype navigation data, wherein the prototype navigation data represents user interactions, transitions, and routing relationships between pages; and
associate the extracted page level metadata, image representations, application level configurations, referenced component metadata, and prototype navigation data, to create a unified and correlated design information model spanning multiple pages and components for downstream parsing, detection, and transformation,
wherein an associator related to the at least one processor correlates and links page-level metadata, image representations, application-level configurations, prototype navigation data, and design system component metadata into a unified cross-referenced structure spanning multiple pages and components for downstream processing, and
wherein the design information comprises page level metadata, application level metadata, referenced component metadata, image representations, and prototype navigation data.

4. The system as claimed in claim 1, wherein to parse the extracted design information, the at least one processor is configured to:
receive the associated design information generated by the extraction, the design information comprising page level metadata, application level configurations, referenced component metadata, image representations, and prototype navigation data;
identify a proprietary metadata format corresponding to the UI/UX design tool from which the design information is extracted;
interpret the identified proprietary metadata format to determine structural, semantic, and relational attributes represented within the design information;
translate the interpreted design information into a unified internal representation independent of the proprietary metadata format; and
construct a self-evolving application model from the unified internal representation, wherein the self-evolving application model is machine learning interpretable and configured for downstream detection, analysis, and transformation operations, and
wherein a parser related to the at least one processor is configured to interpret multiple proprietary UI/UX design tool formats, each having distinct metadata structures, and translate them into a single unified self-evolving application model that is independent of the source tool format.

5. The system as claimed in claim 1, wherein to detect the UI/UX design, the at least one processor is configured to:
receive the self-evolving application model generated by the parsing, the model comprising correlated metadata, image representations, and design system component information;
correlate information across multiple sources, including the design system component library, page design files, and images extracted from the page designs, to establish a unified understanding of the UI/UX design;
perform image pattern analysis on the image representations to identify and segment distinct visual parts of the page design;
determine spatial and relational attributes of each identified part by collecting positional coordinates, dimensional properties, and hierarchical relationships between parts;
classify the identified parts into preliminary categories based on the image pattern analysis and the determined spatial and relational attributes, and assigning confidence scores thereto;
refine the preliminary classifications by comparing the classified parts against page level metadata using positional correspondence, and revising the classifications based on metadata attributes;
further validate and re-classify the refined classifications using metadata from the design system or component library associated with the classified parts; and
finalize the classification results using a multi layered classification process, thereby enabling detection of layouts, UI components, styles, component relationships, data models, navigation paths, and state variations of the page design for downstream analysis and transformation.

6. The system as claimed in claim 1, wherein to analyze the detected design information, the at least one processor is configured to:
receive classification results and page design detections generated by a detector, the classification results comprising identified layouts, UI components, styles, states, relationships, navigation paths, and data model elements;
perform cross page level analysis on the received classification results by applying pattern matching and positional analysis across multiple pages to determine consistency, section types, and structural similarities;
identify reusable sections across pages based on the cross page level analysis, wherein the reusable sections comprise headers, footers, side navigation elements, top navigation elements, popups, menus, and other recurring page sections;
aggregate visual resources across the application, wherein the visual resources comprise icons and images detected across the pages and associated design files;
consolidate multiple page representations corresponding to different personas or different page states by detecting variations of a same page and combining the detected variations into a unified page representation; and
generate enriched analytical output information from the reusable section identification, visual resource aggregation, and page consolidation, wherein the enriched analytical output information facilitates automated transformation of the UI/UX design to the target platform.

7. The system as claimed in claim 2, wherein to transform the analyzed design information, the at least one processor is configured to:
map detected layouts, UI components, styles, states, data models, and navigation flows into framework specific components or platform specific configuration entities instead of generic HTML elements.

8. The system as claimed in claim 2, wherein to transform, the at least one processor is configured to:
reconcile updated UI/UX designs with previously generated target platform outputs to preserve existing developer modifications,
wherein reconciliation comprises identifying differences between previously generated outputs and updated UI/UX designs while preserving existing modifications.

9. The system as claimed in claim 1, wherein to generate target platform compatible outputs, the at least one processor is configured to:
deploy generated configurations or code directly to the target platform through platform integrated interfaces.

10. The system as claimed in claim 1,
wherein an extractor, a parser, a detector, an analyzer, a transformer, and a generator are orchestrated by a centralized service executing a predefined transformation workflow;
wherein the extractor is a tool native service configured to extract design information from UI/UX design files and associate metadata across pages and components;
wherein the parser translates extracted proprietary design metadata into a machine learning interpretable self-evolving application model;
wherein the detector classifies UI elements using combined image pattern analysis, coordinate based metadata analysis, and design system metadata verification;
wherein the analyzer performs cross page analysis to identify reusable components, repeated sections, and consolidated page variations;
wherein the transformer maps analyzed design information into platform specific configuration entities or framework specific components; and
wherein the generator deploys transformed configurations or code directly to a target platform through platform integrated interfaces.

11. The system as claimed in claim 1, wherein to transform, the at least one processor is configured to:
accept user inputs during design review to revise transformation outcomes and improve subsequent transformations.

12. The system as claimed in claim 1,
wherein the application inputs comprise a domain, a sub domain, and an application description defining functional intent and usage context of an application; and
wherein the UI/UX design files are proprietary design artifacts generated by UI/UX design tools.

13. The system as claimed in claim 1, wherein the at least one processor is configured to:
receive application inputs, comprising at least one of a domain, a subdomain, and an application description associated with a software application;
generate personas and user journeys corresponding to the received application inputs, including main flows, alternate flows, and navigation sequences; and
recommend UI design attributes corresponding to the generated personas and user journeys, wherein the UI design attributes comprise at least one of layouts, component placements, field structures, and visual organization.

14. The system as claimed in claim 13, wherein to generate personas and user journeys, the at least one processor is configured to:
analyze the application description to identify functional objectives, business context, and intended usage patterns of the application;
automatically identify one or more user roles associated with the application, wherein each user role is derived based on the analyzed application description;
determine, for each identified user role, an end to end transaction flow, the transaction flow comprising a sequence of user interactions required to accomplish a defined application objective;
derive one or more alternate flows and negative flows for each end to end transaction flow by evaluating optional actions, exception conditions, and validation scenarios associated with the user role;
define sequential navigation actions between application pages, wherein the navigation actions are determined based on the end to end transaction flows, the alternate flows, and the negative flows; and
generate the personas and user journeys as ordered and interlinked navigation sequences that are directly consumable by downstream UI design recommendation and design to target platform transformation operations,
wherein the personas represent abstracted user roles automatically derived from the application inputs,
wherein the user journeys comprise ordered sequences of user interactions defining main flows, alternate flows, and navigation paths across application pages.

15. The system as claimed in claim 13, wherein to recommend the UI design attributes, the at least one processor is configured to:
process the generated personas and user journeys to determine user specific interaction requirements and navigational context for the application;
determine an optimal UI layout for each application page based on the processed personas and user journeys, wherein the layout defines structural arrangement and hierarchical organization of UI elements;
order information within the determined UI layout to reflect interaction priority and usage sequence derived from the user journeys;
segment the application pages into one or more logical screen sections, wherein the segmentation is performed based on functional grouping and interaction relevance identified from the ordered information;
select appropriate UI components for each segmented screen section, wherein the selection is based on the interaction requirements, data capture needs, and display characteristics associated with the personas and user journeys; and
determine visualization formats for presenting information within the selected UI components, wherein the visualization formats are aligned with the layout, segmentation, and component selection to support efficient user interaction,
wherein the UI design attributes include page layouts, UI component placements, field groupings, visual hierarchy, and screen segmentation.

16. The system as claimed in claim 5, wherein the detector further comprises a static data detector configured to classify text present on pages as static labels based on positional and hierarchical relationships, and a dynamic data binding detector configured to re-classify the output of the static data detector to identify dynamic data fields, providing dual-stage classification of static versus dynamic content.

17. The system as claimed in claim 5, wherein the detector further comprises a repeated form section detector configured to perform section pattern matching by comparing structural attributes while ignoring dynamic data content, to identify repeated data collection patterns across sections.

18. A method for transforming at least one of User Interface (UI) design or User Experience (UX) design into target platform outputs, the method comprising:
extracting design information from UI/UX design files, the design information comprising metadata, images, and prototype navigation data;
parsing the extracted design information into a self-evolving application model;
analyzing the parsed design information using machine learning based classification to identify UI components, layouts, styles, states, relationships, data models, and navigation behaviors;
performing cross-page analysis to identify reusable components and consolidate page variations; and
transforming and generating target platform compatible configurations or code, based on the analyzed design information and the cross-page analysis, and deploying the generated outputs to the target platform.

19. A non-transitory computer-readable medium storing instructions which, when executed by one or more processors of an electronic device, cause the electronic device is configured to:
extract design information from one or more UI/UX design files, wherein the design information comprising at least one of page level metadata, application level metadata, referenced component metadata, image representations, and prototype navigation information;
parse the extracted design information into a self-evolving application model;
analyze the parsed design information using machine learning-based classification to identify at least one of UI components, layouts, styles, states, relationships, data models, and navigational behaviors;
perform cross-page analysis to identify reusable components and consolidate page variations; and
transform and generate target platform compatible outputs based on the analyzed design information and the cross-page analysis, wherein the outputs are deployable to at least one low code/no code platform or open source UI framework.
